(19) United States
(12) Patent Application Publication
(10) Pub. No.: US 2015/0180010 A1
(43) Pub. Date: Jun. 25, 2015

(54) Battery Apparatus

(71) Applicant: Ocean Signal Ltd, Margate (GB)

(72) Inventors: Simon NOLAN, Margate (GB); Wayne CARD, Margate (GB); David SHEEKEY, Margate (GB); Stefan KENNEDY, Margate (GB)

(21) Appl. No.: 14/574,979

(22) Filed: Dec. 18, 2014

(30) Foreign Application Priority Data
Dec. 20, 2013 (GB) 1322713.7

(51) Int. Cl. H01M 2/34; H01M 6/42

(52) U.S. Cl. CPC H01M 2/34; H01M 6/42; H01M 2200/00

(57) ABSTRACT

The present invention relates to apparatus with permanent batteries or cells, in particular lithium cells. A first battery or cell 6 is connected to circuit 4 and the other batteries or cells 8 are separated from circuit 4 by switches 20, 22.

### FIELD OF INVENTION

The present invention relates to apparatus with permanent batteries or cells, in particular lithium cells.

### BACKGROUND TO THE INVENTION

Many pieces of electronic equipment need to be able to operate independently of a mains electricity supply and are accordingly powered by batteries. A number of different types of battery have been developed.

Direct lithium batteries are of particular interest since they have a high charge density and a long life. Such batteries are primary (non-rechargeable) batteries and are distinct from lithium-ion rechargeable batteries.

Such primary lithium batteries may be used for example in environments where there is a need to maintain equipment reliably operating for an extended period.

A single cell is a single encased electrochemical unit which exhibits a voltage difference across its terminals. A plurality of such cells make up a battery. Although conventional and informal usage may refer to a single cell as a “battery” in the present application such a single cell will be referred to as a “cell”.

In some applications there is a need for the cell or battery to be mounted in a sealed case, to protect from environmental conditions. For example battery powered apparatus for marine environments may need to have a hermetic outer housing and the electronic circuitry inside powered by the battery. In such cases, it may be undesirable to provide access through the housing to change the battery to avoid the need to seal the access.

A problem with primary lithium batteries and primary lithium cells is that safety issues have arisen in the transport of lithium batteries. In particular, in the event of damage or a short circuit the lithium battery can heat up and this heating can result in a fire. Lithium burns fiercely and lithium batteries are therefore the subject of specific rules for transport, especially since the type of fire extinguisher mounted in the holds of aircraft may not be able to extinguish such a lithium battery fire. Accordingly, transport rules for such cells and batteries are strict.

The safety issues and rules can cause difficulty when shipping products containing direct lithium batteries or direct lithium cells.

There is accordingly a need for electronic equipment containing batteries that can be shipped more safely.

### SUMMARY OF THE INVENTION

According to a first aspect of the invention, there is provided an apparatus comprising:
a housing;
a plurality of lithium cells or batteries contained within the housing; and
a circuit;
wherein a first lithium cell or battery is connected to the circuit; and
each of the other lithium cells or batteries are isolated from the circuit with a switch on each terminal of the other lithium cells or batteries;

wherein the switches are arranged to be open in a first state to physically isolate both terminals of each of the other lithium cells or batteries for transport to power the circuit with only the first lithium cell or battery and closed in a second state to connect each of the plurality of lithium cells or batteries to the circuit for use.

In this way, the lithium cells or batteries are separated for transport to reduce safety risks during transportation, but the circuit may be powered fully by all the cells or batteries during use. Note that the batteries are fully electrically isolated by the physical isolation of the terminals of the other batteries by the switches.

Further developments of the invention are the subject-matter of the dependent claims.

The circuit is arranged to close the switches to connect each of the lithium cells or batteries to the circuit for use, using the power provided by the first lithium cell or battery. In this way, the first cell or battery provides the power to subsequently close the switches.

In an alternative arrangement, there may be provided a switch activation part to keep the switches open in a first state, wherein the switch activation part can be removed to close the switches for use.

The plurality of cells or batteries are connected in series with the switches closed to provide a higher voltage than individual cells or batteries. Alternatively, the plurality of cells or batteries may be connected in parallel.

The housing is permanently sealed. The invention is of particular application in such cases since the housing may be sealed during manufacture with the batteries or cells inside. In this case, the apparatus must be shipped with the batteries inside.

The circuit may operate as a distress beacon and/or to provide marine marine alerting, monitoring and/or communications services.

The apparatus may comprise a plurality of lithium batteries each with no more than 2 g of Li.

Alternatively, the apparatus may comprise a plurality of lithium cells each with no more than 1 g of Li.

### BRIEF DESCRIPTION OF THE DRAWINGS

An example of the invention will now be described with reference to the accompanying diagrams, in which:

FIG. 1 is a circuit diagram of a first example of apparatus according to the invention;

FIG. 2 is a circuit diagram of a second example of apparatus according to the invention; and

FIG. 3 is a circuit diagram of a third apparatus according to the invention.

### DETAILED DESCRIPTION

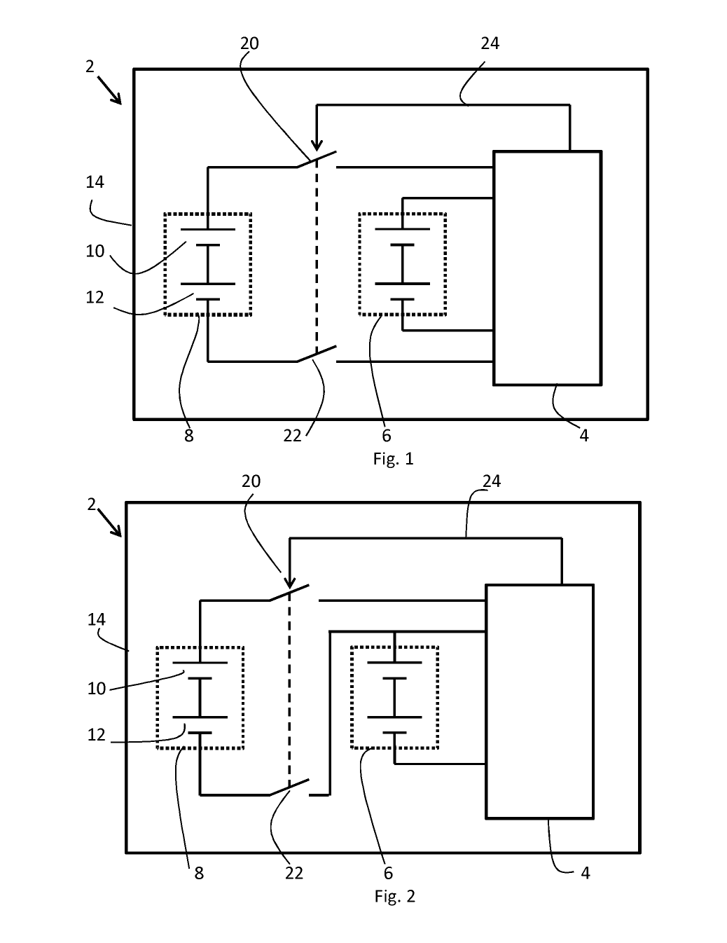

Referring to FIG. 1, an item of electronic equipment 2 contains a circuit 4, which in this case has the function of a power supply control circuit and other functions, and a plurality of batteries 6, 8. In the example shown, each of the batteries 6, 8 is a direct lithium battery containing two lithium cells 10,12.

The outer housing 14 of the item of electronic equipment is a hermetic housing designed to protect the contents of the equipment from the environment. In this specific example the equipment 2 is marine safety equipment, in particular a radio beacon, and the outer housing 14 is intended to protect the electronics from water damage.

The housing 14 is not designed to be opened by the consumer. Accordingly, the batteries 6, 8 are shipped inside the housing 14 of the electronic equipment 4.

First battery 6 is connected to the circuit 4 inside the housing.

Second battery 8 is not connected to the circuit 4. Instead, a first switch 20 and a second switch 22 are provided which can be actuated along switch control line 24 to form a connection between the second battery and the power supply circuit.

The switches used are not transistor switches. Even when a transistor is off, it still maintains some form of connection though the solid state body of the transistor that might in principle switch on and be shorted. Instead, the switches are physical switches that fully isolate the second battery 8.

Both switches operate to physically isolate the second battery from the circuit 4. By providing two switches, one on each of the terminals of the second battery 8, the battery is fully isolated.

For shipment, the first and second switches 20, 22 are in the open state and accordingly second battery 8 is completely disconnected from the rest of the electronic equipment. This ensures complete electrical separation between the first and second batteries. Accordingly, even if the first battery were to short circuit or overheat, the quantity of lithium that might be affected is limited to the lithium in the first battery and this increases the safety of the apparatus.

In use, the equipment uses more power than can be provided by the first battery alone. Accordingly, the user actuates the circuit 4 which at this stage is powered by the first battery alone. This sends a signal down the switch control line 24 which closes first and second switches 20, 22 to connect the second battery 8 additionally to the first battery. As will be apparent from FIG. 1, in this arrangement the batteries are connected in parallel.

In this state the electronic equipment is in use with the full power of both batteries.

The indicated switches in this arrangement are relay switches.

Accordingly, the electronic equipment may be safely shipped with two batteries inside and accordingly with more electrical power capability. The electrical safety corresponds to a device with a single battery inside it, but the unit may nevertheless operate with the power of more than just one battery.

Units arranged in this way are not merely safer but may also more easily meet requirements for shipping units by air.

When the unit is turned off, for storage or onwards transport, the circuit 4 opens the first and second switches 20, 22 and disconnects the batteries 6, 8 for storage or shipment.

The product is always shipped in the safe, off state.

In an alternative embodiment, the switches 20, 22 may operate to permanently close after the unit has shipped to permanently connect the batteries to the electronic circuitry.

In a further alternative, the switches 20, 22 are not controlled by circuit 4 but by a magnet or physical switch. In this case, the product may be shipped with a switch activation part that may be an external magnet or physical control part mechanically engaging the switches 20, 22 that ensures that the switches 20,22 remain open. Once the product has arrived at its destination the switch activation part may be removed closing the switches 20, 22 for use. In this case, the circuit 4 does not function as a power supply control circuit since the control of the switches is provided by the switch activation part.

FIG. 2 illustrates an alternative arrangement. In this case, the batteries are arranged in series, not in parallel. Apart from this distinction, the circuit operates in the same way as the circuit in FIG. 1. In this case, the electronic equipment may be operated with the higher voltages of the batteries 6, 8 in series.

Alternative arrangements are possible. Instead of two batteries, a larger number of batteries may be provided. Each of the batteries has a switch at each end so that each of the batteries are separated from each other during shipment.

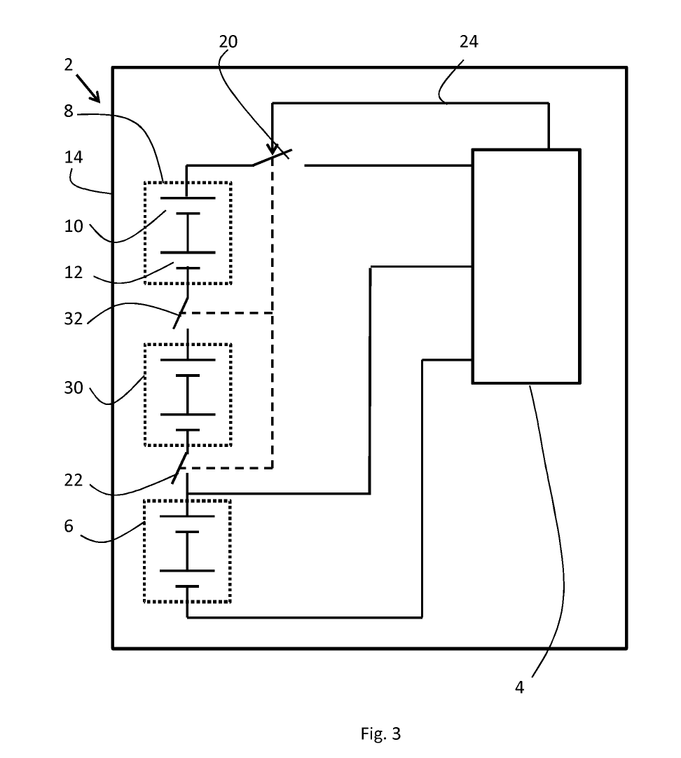

FIG. 3 illustrates such a circuit. First battery 6 is connected to circuit 4 during shipment and switches 20,22,32 isolate second battery 22 and third battery 32 during shipment. Note that there is a switch 20,22,32 at each end of each of the second and third batteries 22,32 so that both batteries are fully isolated but because of the series configuration there are three switches and two batteries. Also note that switch 32 separates the second and third batteries during shipment so that each battery is physically and electrically isolated from each other battery. The switches 20,22,32 are all operated by single switch line 24.

Instead of batteries 6, 8, 30 the electronic equipment may have single cells. In this case, each cell may have relays at each end to separate the cells during transport with a first cell connected to the power supply control circuit to provide the power to close the relays and connect all the cells.

It will be appreciated that more than just two or three cells may be provided, for example two to eight cells.

Although the above embodiments relate to primary lithium cells or batteries, i.e. non-rechargeable batteries, similar issues may apply to secondary lithium ion batteries and the same approach can be used for such batteries.

Reed, relay or mechanical switches 20, 22 are preferred to electronic switches such as transistors to avoid the risk of short circuits in such electronic switches. Further, equipment having transistors is unlikely to meet the requirements for shipping products by air.

1. Apparatus comprising:
a housing;
a plurality of lithium cells or batteries contained within the housing; and
a circuit;
wherein a first lithium cell or battery is connected to the circuit; and
each of the other lithium cells or batteries are isolated from the circuit with a switch on each terminal of the other lithium cells or batteries;
wherein the switches are arranged to be open in a first state to physically isolate both terminals of each of the other lithium cells or batteries for transport to power the circuit with only the first lithium cell or battery and closed in a second state to connect each of the plurality of lithium cells or batteries to the circuit for use.

2. Apparatus according to claim 1, wherein
the circuit is arranged to close the switches to connect each of the lithium cells or batteries to the circuit for use, using the power provided by the first lithium cells or batteries.

3. Apparatus according to claim 1 further comprising a switch activation part to keep the switches open in a first state, wherein the switch activation part can be removed to close the switches for use.

4. Apparatus according to claim 1 wherein the plurality of cells or batteries are connected in series.

5. Apparatus according to claim 1 wherein the plurality of cells or batteries are connected in parallel.

6. Apparatus according to claim 1 wherein the housing is permanently sealed.

7. Apparatus according to claim 1 wherein the circuit operates as a distress beacon and/or to provide alerting, marine monitoring and/or communications services.

8. Apparatus according to claim 1, comprising a plurality of lithium batteries each with no more than 2 g of Li.

9. Apparatus according to claim 1, comprising a plurality of lithium cells each with no more than 1 g of Li.

10. Apparatus according to claim 1 wherein the lithium cells or batteries are primary lithium cells or batteries.
